(19) United States
(12) Patent Application Publication
(10) Pub. No.: US 2020/0353434 A1
(43) Pub. Date: Nov. 12, 2020

(54) METHODS AND SYSTEMS FOR SOCK-LOADING FIXED BED REACTORS

(71) Applicant: ExxonMobil Research and Engineering Company, Annandale, NJ (US)

(72) Inventors: Suriyanarayanan Rajagopalan, Spring, TX (US); Thomas R. Kiliany, JR., Spring, TX (US)

(21) Appl. No.: 16/816,921

(22) Filed: Mar. 12, 2020

Related U.S. Application Data
(60) Provisional application No. 62/827,412, filed on Apr. 1, 2019.

(51) Int. Cl. B01J 8/02

(52) U.S. Cl. CPC B01J 8/0278; B01J 2208/00893; B01J 8/0271; B01J 8/025

(57) ABSTRACT

Provided herein are methods for effectively loading reactor material into fixed bed reactors. The subject methods and systems for loading catalyst particles and inert particles onto a reactor bed utilize a novel sock having a helical-shape that can restrict reactor material traveling through the elevation of the fixed bed reactor to the reactor bed and avoid damaging the reactor material upon impact. The sock comprises a cylindrical tube having a plurality of helixes. Each helix of the cylindrical tube has a downward slope. The downward slope of each helix exceeds an angle of repose of the reactor material. The present methods and system are particularly effective for improving the performance of reactor bed configurations of vertically-oriented fixed bed reactors and flow distribution through the bed at designated operating conditions.

### CROSS-REFERENCE TO RELATED APPLICATIONS

This application claims priority to U.S. Provisional Application Ser. No. 62/827,412 filed Apr. 1, 2019, which is herein incorporated by reference in its entirety.

### FIELD OF THE INVENTION

The present invention generally relates to methods and systems of loading a fixed bed reactor and more particularly, sock-loading methods and systems for preventing free-fall of catalyst and inert material.

### BACKGROUND OF THE INVENTION

In fixed bed reactors, a catalyst bed is often sandwiched between two inert layers positioned adjacent to the catalyst bed. During the start-up of the reactor, catalyst can be loaded into the fixed bed reactor with a dense-loader. On the other hand, inert particles are often piled into the reactor and onto a bed from a hopper located at the top of the fixed bed reactor. The height of the fixed bed reactor, however, can be over one hundred (100) feet, particularly when multiple catalyst beds are employed in the fixed bed reactor and separated by a distributor tray and/or manway. Therefore, a hose or sock is used. The sock extends straight down from the top of the fixed bed reactor to the reactor bed. To prevent a steep free-fall of inert particles (or a fall greater than twenty (20) feet), the sock can be tied to the reactor wall at several locations and stop the inert particles from falling the entire height of the reactor. However, this methodology is cumbersome and unwieldly and does not halt the impact of free-falling inert particles.

During the free-fall, inert particles can accelerate to high speeds before landing, causing damage and breakage. Such damage and breakage can: (1) compromise the integrity of the inert particles; (2) weaken the inert particles (typically spheres sized between one-quarter inch and one inch) designed to withstand a high-pressure reactor environment; (3) cause excessive pressure drops in the reactor due to smaller pieces of inert particles created from the breakage; (4) lowers the economic flow rates; and (5) can lead to catalyst movement out of the reactor to a downstream pipeline due to lack of integrity of the inert particles.

A need exists, therefore, for improved methodologies and systems for making a fixed bed reactor, particularly, methods for loading inert materials into the fixed bed reactor that can produce a reactor bed that will maintain its integrity, avoid later plugging of the reactor bed, optimize process efficiencies by maintaining high catalyst activity and low pressure drops, reduce catalyst contamination, and plant shutdowns.

### SUMMARY

Provided herein is a sock for loading reactor material onto a reactor bed of a fixed bed reactor. In an aspect, the fixed bed reactor has a manway and at least one reactor bed. In an aspect, the fixed bed reactor can have a plurality of reactor beds. The sock comprises a cylindrical tube having a plurality of helixes. Each helix of the cylindrical tube has a downward slope. The downward slope of each helix exceeds the angle of repose of the reactor material. The sock has a proximal opening and a distal opening. In an aspect, the proximal opening of the cylindrical tube can be positioned at the manway of a fixed bed reactor, and the distal opening can be positioned at or near the reactor bed. Therefore, the sock can extend from the manway of the fixed bed reactor to the reactor bed.

In an aspect, the sock can comprise a plurality of segments. In an aspect, each segment is between about 10 feet and about 20 feet. In an aspect, the segments are configured to snap together. In an aspect, the sock is configured to load inert particles into the fixed bed reactor. In an aspect, the sock is configured to load catalyst particles into the fixed bed reactor. In an aspect, the sock is a canvas sock made of or substantially made of canvas material. In an aspect, the sock is a plastic made of or substantially made of plastic material. In an aspect, the sock is a combination of canvas material and plastic material. In an aspect, the sock can have a skeleton to avoid impediment of free-flowing reactor material. In an aspect, the skeleton is a metal skeleton. In an aspect, the sock is supported by a polymer skeleton. In an aspect, the skeleton is a combination of metal skeleton and polymer skeleton.

Also provided herein are methods of making a fixed bed reactor. The methods comprise the steps of providing a sock for loading reactor material into a fixed bed reactor, and loading reactor material onto a bed of the fixed bed reactor. The sock comprises a cylindrical tube having a plurality of helixes. Each helix of the cylindrical tube has a downward slope. The downward slope of each helix exceeds the angle of repose of the reactor material. The flow of reactor material through the sock to the reactor bed is restricted. In an aspect, inert particles are loaded directly onto the reactor bed. In an aspect, catalyst particles are dense loaded onto the reactor bed on top of inert particles. In an aspect, inert particles are loaded on top of catalyst particles on the reactor bed. In an aspect, two socks are coiled around each other to form a double helix and configured to transfer the reactor material through each sock.

Further provided herein is a system for loading reactor material onto a reactor bed. The system comprises a sock for loading reactor material onto a reactor bed of a fixed bed reactor and a fixed bed reactor having a manway and at least one reactor bed. The sock comprises a cylindrical tube having a plurality of helixes. Each helix of the cylindrical tube has a downward slope. The downward slope of each helix exceeds the angle of repose of the reactor material. The sock is connected to the fixed bed reactor at one end and open at the other end for depositing reactor materials onto the reactor bed. In an aspect, the system further comprises a hopper configured to load reactor material onto the fixed bed reactor. The hopper is connected to the reactor and/or the sock. In an aspect, the system further comprises a dense loading system configured to load catalyst particles onto the reactor bed. In an aspect, two socks can be coiled around each other to form a double helix configured to transfer the reactor material through each sock.

### BRIEF DESCRIPTION OF THE DRAWINGS

FIG. 1 shows prior art methods of utilizing a sock where inert particles travel excessive depths and fall, hitting either the reactor wall or other reactor materials.

FIG. 2A shows the present sock used in connection with methods and systems described herein. The sock is in the shape of a helix where the slope of the helix must be greater than the angle of repose of the reactor material particles (inerts or catalysts).

FIG. 2B shows two socks are coiled around each other to form a double helix and configured to transfer the reactor material through each sock.

FIG. 3 shows that the slope of the helix is greater than the angle of repose of the reactor materials and the helical diameter and less than the reactor manway diameter.

FIG. 4 is the loading drawing for the top reactor bed (Bed 1) of the Example I.

FIGS. 5A and 5B represent the loading drawings for reactor bed, Bed 2 and reactor bed, Bed 3 of Example I.

FIGS. 6A and 6B show reactor materials loaded into the fixed bed reactor under two different but exemplary loading scenarios.

### DESCRIPTION OF THE PREFERRED EMBODIMENTS

Before the present methods and devices are disclosed and described, it is to be understood that unless otherwise indicated this invention is not limited to specific compounds, components, compositions, reactants, reaction conditions, ligands, catalyst structures, metallocene structures, or the like, and as such may vary, unless otherwise specified. It is also to be understood that the terminology used herein is for the purpose of describing particular embodiments only and is not intended to be limiting.

For the purposes of this disclosure, the following definitions will apply:

As used herein, the terms “a” and “the” as used herein are understood to encompass the plural as well as the singular.

The term “angle of repose” refers to the steepest angle of descent or dip relative to the horizontal plane to which reactor material can be piled without slumping. At this angle, the material on the slope face is on the verge of sliding. For the reactor materials described herein, the angle of repose can range from 0° to 90°

The terms “catalyst system” and “catalyst” are used interchangeably herein.

The terms “inerts,” “inert particles,” “support balls” and “support media” are used interchangeably herein.

As used herein, the term helix (in the singular) or helixes (in the plural) refer to a type of a curve in three-dimensional space where a tangent line drawn at any point along the curve makes a constant angle with a fixed line called the axis. Examples of helixes are coil springs and the handrails of spiral staircases. In addition, DNA molecules are formed as two intertwined helixes, and many proteins have helical substructures, known as alpha helixes. Another example is a “filled-in” helix—for example, a “spiral” (helical) ramp—is called a helicoid.

The term “helical diameter” refers to the diameter of the circle that would be obtained with the two-dimensional projection of the three-dimensional helix.

The term “support,” “support media,” “support balls” and “inerts” are used interchangeably and include any support material, or a porous support material, including inorganic or organic support materials. Non-limiting examples of inorganic support materials include inorganic oxides and inorganic chlorides. Other carriers include resinous support materials such as polystyrene, functionalized or organic supports, such as polystyrene, divinyl benzene, polyolefins, or polymeric compounds, zeolites, talc, clays, or any other organic or inorganic support material and the like, or mixtures thereof.

As described herein, a fixed bed reactor 12 utilizes catalyst to carry out chemical reactions. In this type of reactor, inert particles are essential to prevent migration of the catalyst or adsorbent through the bottom screens or distributor/collector. Inert particles 14, sometimes referred to herein as support balls or support media, can be graded by size and layered to retain the reactor bed 18. As used herein, the term “reactor bed” refers collectively to the catalyst bed (amount of catalyst alone) and any one or more inert layers. Size selection of the inert particles can depend on the reactor and catalyst size, and other parameters such as a bottom screen opening and total available height for the support media.

More specifically, in the fixed bed reactor 18, catalyst particles 16 and inert particles 14, collectively referred to as reactor materials, are held in place with respect to a fixed reference frame and do not move. In designing the fixed bed reactor 18, material and energy balances are required for both a bulk fluid occupying an interstitial region between catalyst particles and catalyst particles where chemical reactions occur. More specifically, during a catalytic reaction, reactant is transported from a bulk fluid to the exterior surface of the catalyst pellet (referred to herein as a catalyst particle) and from the external surface into the catalyst pellet. Adsorption, chemical reactions and desorption occurs at catalytic sites. Product is then transported from within the catalyst to the external surface of the catalyst and then into the bulk fluid. The coupling of these transport processes can lead to concentration and temperature gradients within the catalyst pellet, and between the catalyst surface and bulk fluid, or both.

The size of inert particles is typically between about 5 mm and about 60 mm. As described herein, small inert particles can be between about 6 mm and about 15 mm. On the other hand, large inert particles can be between 25 mm and 50 mm.

As used herein, catalyst can be extruded, pelletized and/or otherwise provided in the form of extrudates or quadrilobes. In an aspect, a catalyst particle can be an elongated form where catalyst particles have a length/diameter ratio (i.e., “L/D ratio”) of greater than 1. Catalyst particles can have an average L/D ratio of from about 1 to about 8, or from about 2 to about 6. When the term “L/D” is used in the context of a catalyst particle herein, the L/D ratio is measured with the dimension L being determined by the maximum dimension of the catalyst along any axis of the catalyst, with the dimension D being determined as the maximum dimension of the catalyst measured along an axis perpendicular to the L axis. When using a catalyst particle with an L/D ratio of greater than about 1, or even more particularly, of about 2 or greater, it is preferred that the processes herein are utilized in conjunction with the dense loading process, particularly when the reactor has an internal diameter of at least about 8 feet, or even 12 feet or more.

Catalyst can include zeolites which have the specified values of Constraint Index and silica:alumina ratio include zeolites having a ZSM-5 structure such as ZSM-5, ZSM-11, ZSM-12, ZSM-35, ZSM-38 and ZSM-48, which are described in U.S. Pat. No. 3,702,886 (ZSM-5), U.S. Pat. No. 3,709,979 (ZSM-11), U.S. Pat. No. 3,832,449 (ZSM-12), U.S. Pat. No. 4,076,842 (ZSM-23) and U.S. Pat. No. 4,016,245 (ZSM-35), U.S. Pat. No. 4,046,859 (ZSM-38) and U.S. Pat. No. 4,397,827 (ZSM-48), and reference is made to these patents for details of these zeolites, their preparation and properties. Of these zeolites, ZSM-5 is preferred.

For example, catalyst as employed in the oxygenate conversion reaction may comprise at least one medium pore aluminosilicate zeolite, e.g., having a Constraint Index of 1-12 (as defined in U.S. Pat. No. 4,016,21). As noted immediately above, suitable zeolites can include, but are not necessarily limited to, ZSM-5, ZSM-11, ZSM-12, ZSM-22, ZSM-23, ZSM-35, ZSM-48, and the like, and combinations thereof. ZSM-5 is described in detail in U.S. Pat. No. 3,702,886 and RE 29,948. ZSM-11 is described in detail in U.S. Pat. No. 3,709,979. ZSM-12 is described in U.S. Pat. No. 3,832,449. ZSM-22 is described in U.S. Pat. No. 4,556,477. ZSM-23 is described in U.S. Pat. No. 4,076,842. ZSM-35 is described in U.S. Pat. No. 4,016,245. ZSM-48 is more particularly described in U.S. Pat. No. 4,234,231. In an aspect, the zeolite can comprise or be ZSM-5.

In an aspect, catalyst can be a zeolite having a silica to alumina molar ratio of at least 20, such as from about 20 to about 600, from about 30 to about 200, or from about 40 to about 80. For example, the silica to alumina molar ratio can be at least 40, such as at least about 60, at least about 80, at least about 100, or at least about 120. Additionally, the silica to alumina molar ratio can be about 600 or less, such as about 400 or less, or about 200 or less, or about 160 or less, or about 120 or less, or about 100 or less. In particular aspects, the silica to alumina molar ratio can be at least 40, for example from about 40 to about 200.

Alternately, catalysts can include one or more transition metals. In one aspect, the transition metal can include or be a Group 12 metal from the IUPAC periodic table (sometimes designated as Group IIB), such as Zn and/or Cd. The transition metal can be incorporated into the zeolite in any convenient form (such as in metal form, as an ion, as an organometallic compound, etc.) and by any convenient method, such as by impregnation and/or by ion exchange.

As to the inert particles, there are various commercially available support media technologies designed to fit a range of applications. For example, Denstone® 2000 support balls provided by Saint-Gobain NorPro are exemplary inert particles 14 designed to prevent rapid depressurization and have improved impact resistance and compressive strength that safe guards against channeling and plugging of the bed or fouling of catalyst 16 caused by chipping and breakage of the support media. Table 1A provides the chemical properties of this particular commercially available inert particles and Table 1B provides other properties.

TABLE 1A
Denstone ® 2000 Support Balls Chemical Properties

| | min % | max % |
|---|---|---|
| SiO₂ | 67.0 | 77.0 |
| AI₂O₃ | 18.0 | 26.0 |
| Fe₂O₃ | — | 1.7 |
| TiO₂ | — | 1.5 |
| CaO | — | 1.0 |
| MgO | 0 | 1.0 |
| Na₂O | 0 | 2.0 |
| K₂O | — | 6.0 |
| AI₂O₃ + SiO₂ | 90.0 | 96.0 |

TABLE 1B
Other Properties

| | |
|---|---|
| Leachable Iron | ≤0.1% |
| Sphericity | <1.25 |
| Max Operating Temperature | 1000° C. |
| MOHS Hardness | >6.5 |
| Attrition (weight loss) | ≤1.0% |
| Water Absorption | 2.0-6.0% |

Table 2 identifies the physical properties of the Denstone® 2000 support balls.

TABLE 2
Denstone ® 2000 Support Balls Physical Properties

| | |
|---|---|
| Crush Strength | Bulk Density* |

| | | | | | | |
|---|---|---|---|---|---|---|
| Nominal Size | Diameter (mm) | (lb) | (kg) | (N) | (kg/m³) | (lb/ft³) |

| Mm | In | min | Max | Min | Min | min | Min | Max | min | Max |
|---|---|---|---|---|---|---|---|---|---|---|
| 3 | ⅛ | 2.8 | 4.3 | 50 | 22.7 | 223 | 1281 | 1378 | 80 | 86 |
| 6 | ¼ | 6.1 | 8.1 | 160 | 72.5 | 711 | 1281 | 1378 | 80 | 86 |
| 10 | ⅜ | 8.4 | 10.9 | 250 | 113 | 1109 | 1281 | 1378 | 80 | 86 |
| 13 | ½ | 11.4 | 14.5 | 500 | 227 | 2227 | 1281 | 1378 | 80 | 86 |
| 16 | ⅝ | 14.5 | 17.5 | 600 | 273 | 2678 | 1281 | 1378 | 80 | 86 |
| 19 | ¾ | 17.8 | 22.4 | 1050 | 477 | 4679 | 1281 | 1378 | 80 | 86 |
| 25 | 1 | 23.6 | 29.2 | 1750 | 795 | 7799 | 1281 | 1378 | 80 | 86 |
| 32 | 1-¼ | 30.0 | 35.1 | 2000 | 900 | 8829 | 1281 | 1378 | 80 | 86 |
| 38 | 1-½ | 35.1 | 40.1 | 2000 | 900 | 8829 | 1281 | 1378 | 80 | 86 |
| 50 | 2 | 48.3 | 55.9 | 2000 | 900 | 8829 | 1281 | 1378 | 80 | 86 |

Another example of commercially available inert particles is the Denstone® 57 support balls. These inert particles are designed to retain physical properties after being exposed to thermal cycling, prevent poisoning and contamination of the catalyst and plugging of the bed. Table 3A provides the chemical properties of this commercially available support media and Table 3B provides other properties. Also, in Table 4 below, the physical properties of the Denstone® 57 support balls are provided.

TABLE 3A
Denstone ® 57 Support Balls Chemical Properties

| | min % | max % |
|---|---|---|
| SiO₂ | 64.0 | 75.0 |
| AI₂O₃ | 19.0 | 26.0 |
| Fe₂O₃ | — | 1.7 |
| TiO₂ | — | 1.5 |
| CaO | — | 0.7 |
| MgO | — | 0.5 |
| Na₂O | — | 2.9 |
| K₂O | — | 4.8 |
| AI₂O₃ + SiO₂ | 90.0 | 96.0 |

TABLE 3B
Other Properties

| | |
|---|---|
| Leachable Iron | ≤0.1% |
| Sphericity | <1.25 |
| Max Operating Temperature | 1000° C. |
| MOHS Hardness | >6.5 |
| Attrition (weight loss) | ≤1.0% |

TABLE 4A
Denstone ®57 Support Balls Physical Properties

| Nominal | | Diameter | | Crush Strength | | | |
|---|---|---|---|---|---|---|---|
| Size | | (mm) | | (lb) | (kg) | (N) | Water |
| mm | In | Min | Max | min | Min | Min | Absorption |
| 3 | ⅛ | 2.8 | 4.3 | 50 | 22.7 | 223 | ≤3.0% |
| 6 | ¼ | 6.1 | 8.1 | 120 | 55 | 540 | ≤1.0% |
| 10 | ⅜ | 8.4 | 10.9 | 200 | 90 | 883 | ≤0.4% |
| 13 | ½ | 11.4 | 14.5 | 370 | 170 | 1668 | ≤0.4% |
| 16 | ⅝ | 14.5 | 17.5 | 500 | 230 | 2256 | ≤0.4% |
| 19 | ¾ | 17.8 | 22.4 | 950 | 430 | 4218 | ≤0.4% |
| 25 | 1 | 23.6 | 29.2 | 1400 | 635 | 6229 | ≤0.4% |
| 32 | 1-¼ | 30.0 | 35.1 | 2000 | 900 | 8829 | ≤0.4% |
| 38 | 1-½ | 35.1 | 40.1 | 2000 | 900 | 8829 | ≤0.4% |
| 50 | 2 | 48.3 | 55.9 | 2000 | 900 | 8829 | ≤0.4% |

TABLE 4B
Denstone ®57 Support Balls Physical Properties (continued)

| Nominal | | Diameter | | Bulk Density* | | | |
|---|---|---|---|---|---|---|---|
| Size | | (mm) | | (kg/m³) | | (lb/ft³) | |
| mm | In | Min | Max | Min | max | Min | Max |
| 3 | ⅛ | 2.8 | 4.3 | 1282 | 1426 | 80 | 89 |
| 6 | ¼ | 6.1 | 8.1 | 1282 | 1426 | 80 | 89 |
| 10 | ⅜ | 8.4 | 10.9 | 1282 | 1426 | 80 | 89 |
| 13 | ½ | 11.4 | 14.5 | 1282 | 1426 | 80 | 89 |
| 16 | ⅝ | 14.5 | 17.5 | 1282 | 1426 | 80 | 89 |
| 19 | ¾ | 17.8 | 22.4 | 1250 | 1394 | 78 | 87 |
| 25 | 1 | 23.6 | 29.2 | 1250 | 1394 | 78 | 87 |
| 32 | 1-¼ | 30.0 | 35.1 | 1250 | 1394 | 78 | 87 |
| 38 | 1-½ | 35.1 | 40.1 | 1250 | 1394 | 78 | 87 |
| 50 | 2 | 48.3 | 55.9 | 1250 | 1394 | 78 | 87 |

Yet another example of commercially available inert particles is the Denstone® 99 support balls. This support media is designed to be chemical-resistant, necessary to avoid polymerization and can withstand extreme temperatures while having good heat retention or equilibration media. Table 5A provides the chemical properties of this commercially-available inert particles and Table 5B provides other properties. Also, Table 6 provides the physical properties of the Denstone® 99 inert particles.

TABLE 5A
Denstone ® 99 Support Balls Chemical Properties

| | min % | max % |
|---|---|---|
| SiO₂ | — | 0.2 |
| AI₂O₃ | 99.0 | — |
| Fe₂O₃ | — | 0.2 |
| TiO₂ | — | 0.5 |
| CaO + MgO | — | 0.2 |
| Na₂O + K₂O | — | 0.4 |
| AI₂O₃ + SiO₂ | 99.2 | — |

TABLE 5B
Other Properties

| | |
|---|---|
| Leachable Iron | 0.01% |
| Sphericity | <1.10 |
| Max Operating Temperature | 1650° C. |
| Attrition (weight loss) | ≤0.5% |
| Water Absorption | ≤7.0% |

Tables 6A & 6B immediately below identify the physical properties of the Denstone® 99 support balls.

TABLE 6A
Denstone ®99 Support Balls Physical Properties

| Nominal | | Diameter | | Crush Strength | | |
|---|---|---|---|---|---|---|
| Size | | (mm) | | (lb) | (kg) | (N) |
| Mm | in | Min | Max | min | Min | Min |
| 1.5 | 1/16 | 1.0 | 2.0 | 30 | 13 | 128 |
| 3 | ⅛ | 2.8 | 5.3 | 110 | 50 | 491 |
| 6 | ¼ | 5.3 | 8.1 | 220 | 100 | 981 |
| 8 | 5/16 | 6.6 | 9.4 | 330 | 150 | 1471 |
| 10 | ⅜ | 7.9 | 11.2 | 440 | 200 | 1962 |
| 13 | ½ | 11.2 | 15.0 | 1322 | 600 | 5886 |
| 19 | ¾ | 17.5 | 22.4 | 2202 | 1000 | 9810 |
| 25 | 1 | 22.4 | 29.2 | 3083 | 1400 | 13734 |
| 38 | 1-½ | 35.1 | 40.1 | 3965 | 1800 | 17658 |
| 50 | 2 | 48.3 | 55.9 | 4846 | 2200 | 21582 |
| 75 | 3 | 71.1 | 81.3 | 4846 | 2200 | 21582 |

TABLE 6B
Denstone ® 99 Support Balls Physical Properties (continued)

| Nominal | | Diameter | | Bulk Density | | | |
|---|---|---|---|---|---|---|---|
| Size | | (mm) | | (kg/m³) | | (lb/ft³) | |
| mm | In | min | Max | min | max | Min | Max |
| 1.5 | 1/16 | 1.0 | 2.0 | 1682 | 2050 | 105 | 128 |
| 3 | ⅛ | 2.8 | 5.3 | 1850 | 2050 | 115 | 128 |
| 6 | ¼ | 5.3 | 8.1 | 1850 | 2050 | 115 | 128 |
| 8 | 5/16 | 6.6 | 9.4 | 1850 | 2050 | 115 | 128 |
| 10 | ⅜ | 7.9 | 11.2 | 1850 | 2050 | 115 | 128 |
| 13 | ½ | 11.2 | 15.0 | 1850 | 2050 | 115 | 128 |
| 19 | ¾ | 17.5 | 22.4 | 1800 | 2050 | 112 | 128 |
| 25 | 1 | 22.4 | 29.2 | 1762 | 2050 | 110 | 128 |
| 38 | 1-½ | 35.1 | 40.1 | 1682 | 2002 | 105 | 125 |
| 50 | 2 | 48.3 | 55.9 | 1682 | 2002 | 105 | 125 |
| 75 | 3 | 71.1 | 81.3 | 1682 | 2002 | 105 | 125 |

Shapes of the reactor materials (catalyst particles and the inert particles) can include, but are not limited to, spherical spheroidal, ring, cylindrical, trilobe, and quadralobe or other suitable shapes. FIGS. 6A and 6B are support media loading examples. FIG. 6A shows ⅛ inch inert particles 14 loaded on top of ¼ inch inert particles 14 loaded on top of ½ inch inert particles 14. Catalyst particles 16 are then loaded into the reactor and on top of the catalyst 16 are ½ inch inert particles 14. Similarly, FIG. 6B shows catalyst particles loaded on top of two different sized inert particles 14 with another layer of inert particles loaded onto of the catalyst.

Generally, there are many advantages associated with the use of the fixed bed reactor. These advantages can include: (a) the lack of moving parts; (b) the retention of catalyst in the reactor; (c) ease of separation of the reaction mixture from the catalyst particles; (d) heat exchange by the addition of cold gas, a liquid quench, an internal or external heat exchanger(s), or an external wall heat transfer (e.g., in the case of small diameter tubes like bench scale units or multi-tube-bundle reactors); and (e) an adiabatic process. There are numerous configurations of fixed bed catalytic reactors. For example, a common configuration is co-current gas-liquid downflow, described, for instance, by R. Gupta, in “Cocurrent Gas-Liquid Downflow in Packed Beds,” Chapter 19, of the Handbook of Fluids in Motion (1983). Other configurations include co-current upflow and countercurrent operations. A typical fixed bed reactor 12 can be cylindrical (tangent to tangent) with hemispherical heads at the top and the bottom.

But regardless of the specific configuration, the fixed bed reactor can provide the following operational parameters: (1) sufficient volume and residence time for a desired conversion; (2) sufficient mass transfer rate of reactants and products through the gas-liquid interface and through the liquid film on the surface of catalyst particles; (3) effective use of a catalyst particle and active sites throughout the cross section of particles in the reactor bed; (4) uniform flow distribution over entire if) width and length of the bed in an effort to utilize all of the catalyst; (5) conditions where gas and liquid phases can be homogeneously mixed and not separate; (6) conditions where all the catalyst is adequately wetted such that both reactants are present and heat transfers effectively from all zones within the reactor; and (7) effective control of temperature in a safe operating window or effective range to maximize reaction selectivity, product quality, catalyst life, and the like. See e.g., H. Hofmann: “Multiphase Catalytic Packed Bed Reactors”, Catal. Rev. Sci. Eng. 17 (1978) 71-117. However, as noted above, to achieve each of these attributes in a commercial fixed bed reactor, the reactor bed comprising the catalyst bed and the inert layer(s) must maintain its integrity to avoid later plugging of the bed and to optimize process efficiencies by keeping pressure drop lows and catalyst activity high, reducing contamination and process shutdown.

In the petroleum and chemical industries, different methods have been used for loading materials into the fixed bed reactor. In dump loading methodologies, the reactor materials (catalyst and/or inert particles) are simply dumped from containers or buckets into the reactor. If the fixed bed reactor is large, a worker may be located within the fixed bed reactor during the loading and/or after loading to assist in evenly distributing the reactor materials within the reactor. This can create a bed that is not tightly packed or one that does not have uniformity in material distribution.

Another methodology used in the petroleum and chemical industries is “dense loading” or “dense bed loading.” Dense loading is achieved by a mechanical device that can provide a uniform or substantially uniform distribution of catalyst throughout the entire diameter of the reactor, and higher total bed density as the catalyst is being loaded. A dense loading system can increase the loading density by as much as 10-20 percent, depending on the type and shape of catalyst that is being loaded. Dense loading can improve the liquid or gas flow, eliminate catalytic bed settling, and allow for a longer run cycle between catalyst replacements. Typically, a rotary device is positioned in the reactor during the loading process to obtain a feed of reactor material from a hopper (not shown). Reactor material is essentially sprayed in a radial pattern onto the bed in order to produce a uniform, extrudate having an L/D ratio of greater than one. The underlying principle is the bed of reactor material uniformly orientated and distributed within the reactor bed will thereby reduce inconsistencies and voids. Dense loading processes can provide a reactor bed having a voidage a few percentage points less than the voidage obtained by dump loading or sock loading described immediately below.

In addition, “sock loading” or a “sock method” used in the petroleum and chemical industries allows catalyst particles and inert particles to be loaded into the fixed bed reactor via a hose referred to as a “sock.” Sock loading involves placing catalyst 16 or inert particles into a hopper on the top of the reactor manway and discharging particles through a canvas or rubber sock. A loading technician can crimp the sock to restrict free-fall of reactor material as he or she spreads the particles evenly in a random pattern. As the reactor bed level rises, the sock is cut to keep the free-fall of particles to the required distance, and discarded sections are removed from the reactor.

In this method, the hopper having an attached hose which extends to the bottom of the fixed bed reactor or to the particulate matter surface is utilized. The hopper and hose are filled with particles and the particles are released at the bottom of the hose by raising the hose slowly. The resulting reactor bed is in the shape of a cone which can be distributed over the reactor bed by raking. One of the problems that is associated with loading fixed bed reactors by this method is that the reactor bed can contain excessive voids which limit the amount of particulate matter which may be placed or stored. In the case of a catalytic reaction zone or reactor, such voids can, during use, bring about catalyst settling problems, localized hot spots during the exothermic reactions of reactants and the necessity to utilize increased reactor volume.

In sock loading methodologies, the sock (often flexible) is connected to a hopper or manway or flange at the top of the fixed bed reactor extending down into the reactor where the worker can move an outlet (the distal opening) of the sock over the entire area of the catalyst bed or inert layer (referred to collectively as the “reactor bed”). Here, the worker works to achieve a consistent and uniform loading of reactor material. Notwithstanding the added human control of this process, as described above, this methodology often fails to provide consistent fixed bed reactor performance due to breakage, chipping and spall of the reactor material. Thus, the settling of catalyst and inert particles changes the overall volume of the reactor bed thereby producing damage to equipment such as thermowells which have been inserted into the reactor for temperature measurements. In addition, the settling of catalyst particles can reduce the surface of the reactor bed to a level whereby the thermowell is not in contact with the catalyst. Therefore, reaction temperature cannot be properly monitored during the course of a reaction. Excessive voids in a sock-loaded bed can cause poor gas, liquid, or gas-liquid distribution through the reactor bed. This maldistribution often requires decreased throughput or increased temperatures, since the resulting catalyst utilization is low and product specifications may not be met. Settling problems associated with sock-loaded reactor beds can result in damage to another reactor internal, such as baskets, redistribution trays, catalyst supports and quench spargers.

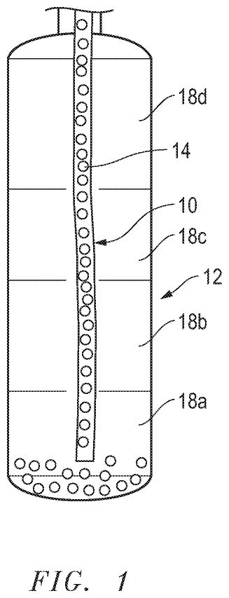

FIG. 1 shows prior art methods of utilizing a sock 10 where inert particles 14 travel excessive depths and fall, hitting either the reactor wall or other reactor materials. During this impact, there is higher possibility for breakage and loss of integrity. In FIG. 1, the fixed bed reactor 12 has four reactor beds 18a, 18b, 18c and 18d and the sock 10 passing through the manway opening.

An additional problem associated with the prior methods of charging catalyst is that the amount of catalyst which can be charged for a given fixed bed reactor volume is determined by the final catalyst density. Thus, one way to increase the bulk density of catalyst present in a reaction zone would be to allow for an increased throughput of reactants at the same severity or the same throughput at lower severity. Thus, more severe reaction conditions and/or increased throughput can be obtained for a given reaction zone volume if an increase in bulk density of the catalyst can be achieved. Fixed bed reactor loading difficulties are not merely reserved for the loading of catalyst into reaction zones or reactors but are found to exist in almost every application where finely divided particulate matter must be loaded into fixed bed reactors. For example, grain, bulk chemicals, fertilizer, steel pellets, crushed rock, rock salt, coal, coke, etc., may be successfully loaded according to this invention. The particles may be in the form of spheres, pellets, extrudates, cylinders, flakes, pills, crystals, granules, etc.

To remedy the shortcomings of sock loading methodologies provided herein are methods and systems for loading reactor material into a fixed bed reactor. The present methods and systems can help avoid adverse process inefficiencies resulting from breakage, chipping and spall of particulate material and inconsistent performance of the fixed bed reactor. The present methods can also improve catalyst effectiveness through maintaining uniform pellet size and shape and subsequently overall uniform heat transfer during reaction processes.

More particularly, methods and systems for improving the loading of reactor materials in “large” fixed bed reactors are provided herein. Typically, the fixed bed reactor is arranged in a vertical orientation and essentially cylindrical in shape. The “large” fixed bed reactors utilized for various processes will have an internal diameter of at least 1 foot, or under some circumstances, at least 3 feet. The term “vertical” means that the fixed bed reactor's longitudinal axis (i.e., the axis of its longest dimension) is in an essentially vertical orientation. For example, where the basic shape of the reactor is cylindrical, the axis of the cylinder would be oriented in the vertical direction. Where the term “diameter” is used in context with a reactor vessel, the term diameter is meant to convey the term “internal diameter” unless otherwise noted. Also, where the term “diameter” is used in context with a reactor bed, it is meant to convey the term “external diameter” unless otherwise noted.

The present methodologies can be utilized in reactor beds which are essentially cylindrical in shape. Furthermore, one or more individual reactor beds can be included within a single reactor. The reactor beds will typically be in a stacked bed configuration, wherein one bed is located at a higher vertical location with respect to the other bed or beds, the beds being situated along the cylindrical axis of the reactor. The term “stacked” means that the reactor beds 18a, 18b, 18c, 18d are oriented one on top of the other with the longitudinal axis of the beds aligned. An individual reactor bed 18 can be (or may not be) separated from each other by a physical space, such as supported by individual reactor bed supports and/or another internal reactor.

As shown in the figures, in the stacked reactor bed configuration, the reactor beds are typically vertically stacked on each other so that the feedstock flow through the reactor bed occurs in series. While multiple reactor beds 18a, 18b, 18c, 18d may be situated in a reactor 12 in segmented or radially situated orientation relative to one another (i.e., from a planar view of the reactor diameter, viewed down the cylindrical axis), certain fixed bed reactors in the refining and chemical industry are single bed reactors, utilizing undivided reactor bed(s) when viewed in a plane orthogonal to the cylindrical axis of the vertical reactor.

While the methods and systems provided herein are particularly suited for loading of large cylindrical vertically oriented reactor beds, they are not so limited (i.e., where the outer diameter of the reactor bed 18 is essentially the same as the inner diameter, i.e., inner wall, of the reactor 12). The present methods and systems are also useful when the reactor bed is segmented into various sections (as viewed from a plane orthogonal to the vertical axis of the reactor), such as in the example of a cylindrical vertical reactor. In the cylindrical vertical reactor 12, the reactor bed area can be segmented into four reactor bed quarters or two annular reactor bed rings 28a, 28b (when viewed in a plane as a circular area). Typically, this configuration includes an outer diameter of the reactor bed to be essentially the same size as the inner diameter (i.e., inner wall) of the reactor bed 18. The methods are useful with other fixed bed reactor configurations. For example, certain reactors have annular rings present in the center or outer diameter of the reactor bed for injection of gas or liquid feedstocks.

Furthermore, the present methods and systems are not limited to use with vertically oriented reactors. The present methods are also useful for horizontal reactors (not shown), i.e., wherein the fixed bed reactor's longitudinal axis (i.e., the axis of it longest dimension) is in an essentially horizontal orientation. In this case, the methods described herein in conjunction with sock loading of both catalyst particles and inert particles may be particularly beneficial. By the term “essentially the same” as used in this paragraph, it is meant that the outer diameter of the reactor bed be at least 95% of the inner diameter of the fixed bed reactor.

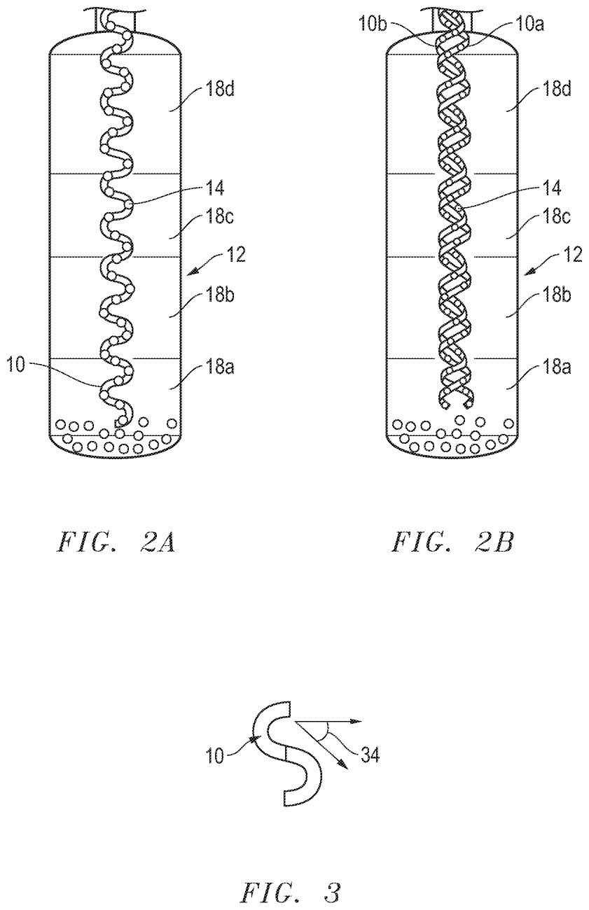

As provided herein and shown in FIG. 2A and FIG. 3, a novel sock 10 is provided. The present sock 10 for loading reactor material (inert particles 14 and catalyst particles 16) onto a reactor bed 18 of a fixed bed reactor 12 comprises a cylindrical tube having a plurality of helixes. Each of the helix of the cylindrical tube has a downward slope. The downward slope of each of the helix exceeds an angle of repose 34 of the reactor material. The sock 10 has a proximal opening and a distal opening. As shown in FIG. 2B, two socks 10a, 10b can be coiled around each other to form a double helix (also referred to as a “double helix configuration”). The double helix being configured to transfer the reactor material (inert particles 14 and catalyst particles 16) through each sock 10. In an aspect, in the double helix configuration, the socks 14a, 14b are cross-supported. In an aspect, the double helix is connected at equidistant points. In an aspect, a cross-supported double helix is similar to that of base pairs in DNA.

The helical shape of the sock 10 together with the angle of repose 34 serves to restrict inert particles 14 while traveling through the system. Specifically, as shown in FIGS. 2 and 3, the present sock has a helical shape to aid reactor materials (14, 16) to travel through the entire elevation supported by the sock 10. The sock 10 comprises a cylindrical tube having a cylindrical cross-section and a diameter that can be maintained over the entire length of the sock. As shown in FIG. 3, the downward slope of the sock 10 should exceed the angle of repose 34 of the reactor materials. This is to avoid bridging and packing of the reactor material in the helical sock. In an aspect, the downward slope of the sock is greater than 45 degrees. The diameter of the sock 10 should be smaller than the diameter of the reactor's manway. In an aspect, the diameter of the sock 10 can be six inches to twelve inches.

### Methods of Determining the Angle of Repose

The measured angle of repose 34 can vary with the test method used. Below are three different test methods to determine an angle of repose.

### Tilting Box Method

This method is appropriate for fine-grained, non-cohesive materials with individual particle size less than 10 mm. The material is placed within a box with a transparent side to observe the granular test material. It should initially be level and parallel to the base of the box. The box is slowly tilted until the material begins to slide in bulk, and the angle of the tilt is measured.

### Fixed Funnel Method

The material is poured through a funnel to form a cone. The tip of the funnel should be held close to the growing cone and slowly raised as the pile grows, to minimize the impact of falling particles. Stop pouring the material when the pile reaches a predetermined height or the base predetermined width. Rather than attempt to measure the angle of the resulting cone directly, divide the height by half the width of the base of the cone. The inverse tangent of this ratio is the angle of repose.

### Revolving Cylinder Method

The material is placed within a cylinder with at least one transparent end. The cylinder is rotated at a fixed speed and the observer watches the material moving within the rotating cylinder. The effect is similar to watching clothes tumble over one another in a slowly rotating clothes dryer. The granular material will assume a certain angle as it flows within the rotating cylinder. This method is recommended for obtaining the dynamic angle of repose, and may vary from the static angle of repose measured by other methods.

Table 7 immediately below provides an approximated angle of repose for certain materials.

TABLE 7
Angle of Repose 34 for Various Materials*

| | Angle of Repose |
|---|---|
| Material (condition) | (degrees) |
| Ashes | 40° |
| Asphalt (crushed) | 30-45° |
| Bark (wood refuse) | 45° |
| Bran | 30-45° |
| Chalk | 45° |
| Clay (dry lump) | 25-40° |
| Clay (wet excavated) | 15° |
| Clover seed | 28° |
| Coconut (shredded) | 45° |
| Coffee bean (fresh) | 35-45° |
| Earth | 30-45° |
| Flour (corn) | 30-40° |
| Flour (wheat) | 45° |
| Granite | 35-40° |
| Gravel (crushed stone) | 45° |
| Gravel (natural w/sand) | 25-30° |
| Malt | 30-45° |
| Sand (dry) | 34° |
| Sand (water filled) | 15-30° |
| Sand (wet) | 45° |
| Snow | 38° |
| Urea (Granular) | 27° |
| Wheat | 27° |

*Glover, T. J. (1995). Pocket Ref Sequoia Publishing. ISBN 978-1885071002.

The present sock 10 can be compacted or folded; but when compacted, the sock can be pulled to extend the entire depth of the reactor. The sock 10 can be made in segments between about 10 feet to about 20 feet, between about 5 to about 30 feet, between about 1 to about 50 feet, between about 1 to about 75 feet, and between about 1 to about 100 feet, and can optionally attach with another segment to form a seamless sock 10. As the reactor materials are loaded in a reactor bed 18, the sock can be shortened by removing the sections of the sock.

In the prior art, the cross-section of the sock 10 is maintained by the flow of reactor materials flowing through the sock 10. However, maintaining the integrity of the cross-section shape is important. In an aspect, the present sock 10 does not have to have structural support along its length to maintain cross-sectional shape integrity. On the other hand, in an aspect, the shape of the cross-section be maintained in the present sock 10 through a pliable support such as the type of metal supports found in air-ducts.

In an aspect, the sock 10 can be made of canvas material. In an aspect, the sock 10 made of canvas material can be supported by a metal skeleton, a polymer skeleton, or a combination thereof in order to maintain the helical shape and avoid impediment of free-flowing reactor material. Alternatively, other types of pliable flexible materials (such as a plastic) can be used to support the sock. In instances where the sock comprises a plurality of segments, the segments can be between 5 and 10 feet in length, and optionally designed to snap into one another to extend the length of the sock. In an aspect, the sock can comprise plastic tubing made of one or more of the following plastic materials including but not limited to polyethylene and polypropylene materials.

Flow maldistribution can take place more frequently in reactors with either very small or very large reactor diameter. Reactors with higher length/diameter ratios (i.e., “L/D ratio”) of greater than about 3 may also be more susceptible to maldistributed catalyst loadings. When the term “L/D” is used in the context of the reactor herein, the L/D ratio is measured with the dimension L being determined along the longest central axis of the fixed bed reactor from the fixed bed reactor tangent-to-tangent lines, and with the dimension D being determined as the maximum internal wall dimension of the fixed bed reactor as measured along an axis perpendicular to the L axis. In the case of a common cylindrical reactor with elliptical heads on each end, the dimension L would be the length of the reactor between the two tangent lines along the axis of the cylinder, and the dimension D would be the internal diameter of the fixed bed reactor measured in a plane orthogonal to the cylinder axis. Methods utilized herein are utilized in fixed bed reactors with L/D ratios greater than about 5, or greater than about 7.

The methods provided herein are particularly beneficial in improving reactor bed flow distributions in two-phase fixed bed reactor 12. In a two-phase reactor process, the feed stream is a mixture of at least one gas phase component and at least one liquid phase component. Such flow streams/feed streams are typical in large hydroprocessing reactors used in the processing of base and intermediate stock hydrocarbon feed streams in petroleum and petrochemical refineries. These processes include: hydrotreating, hydrodesulfurization, hydrodenitrogenation, hydrodemetalation, hydrogenation, hydroisomerization, hydrocracking processes and hydrotreatment of biofuels, particularly those fuels producing base stocks. In these processes, a hydrocarbon based liquid feed stream is mixed with a hydrogen containing gas stream and then exposed to the catalyst in the fixed bed reactor to produce an improved product slate. Typically, such processes are useful in removing sulfur and other contaminants from hydrocarbon feed streams (e.g., hydrodesulfurization, hydrodenitrogenation, or hydrodemetalation processes), reducing the average boiling point of hydrocarbon feed streams (e.g., hydrocracking processes), and/or modifying the hydrocarbon compounds in the hydrocarbon feed streams (e.g., hydrogenation or hydroisomerization processes). In each of these processes, specific types of catalysts will be utilized depending upon the feed stream composition and the product compositions to be sought.

Hydroprocessing operating conditions for fixed bed reactors described herein include two-phase flow including one or more of the following conditions: a temperature of at least about 260° C., for example at least about 300° C.; a temperature of about 425° C. or less, for example about 400° C. or less or about 350° C. or less; a liquid hourly space velocity (LHSV) of at least about 0.1 hr⁻¹, for example at least about 0.3 hr⁻¹, at least about 0.5 hr⁻¹, or at least about 1.0 hr.⁻¹; an LHSV of about 10.0 hr⁻¹ or less, for example about 5.0 hr⁻¹ or less or about 2.5 hr⁻¹ or less; a hydrogen partial pressure in the reactor from about 200 psig (about 1.4 MPag) to about 3000 psig (about 20.7 MPag), for example about 400 psig (about 2.8 MPag) to about 2000 psig (about 13.8 MPag); a hydrogen to feed ratio (hydrogen treat gas rate) from about 500 scf/bbl (about 85 Nm³/m³) to about 10000 scf/bbl (about 1700 Nm³/m³), for example from about 1000 scf/bbl (about 170 Nm³/m³) to about 5000 scf/bbl (about 850 Sm³/m³).

### Example I

### Method of Making a Fixed Bed Reactor Using the Present Sock

### Preparation of the Reactor: Reactor Assembly and Inspection

In the present methods, prior to loading the reactor materials (14, 16), the fixed bed reactor 12 is assembled and inspected. For example, blinds are installed on process lines connected to the reactor (inlet, outlet, and the two quench lines). Dry air (instrument) flow is initiated into reactor to exclude moisture. The fixed bed reactor 12 can be inspected by lifting the inlet nozzle distributor from the 30″ top manway to allow access to the reactor internals and the center manway is removed from all internal trays. The inside of the fixed bed reactor 12 can then be inspected and the dimensions verified with fabrication drawings. Next, bolts are tightened and any required ceramic rope packing or gaskets are installed. Debris is removed.

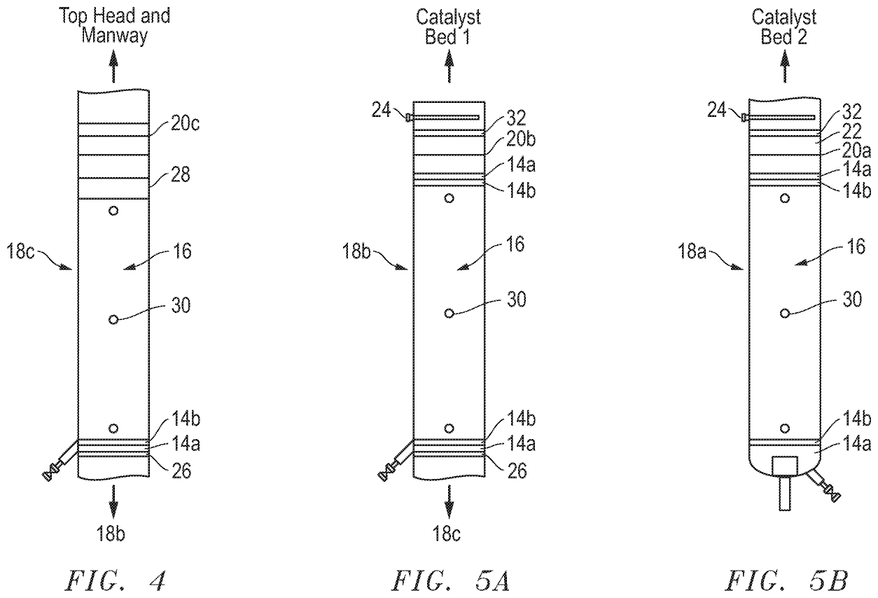

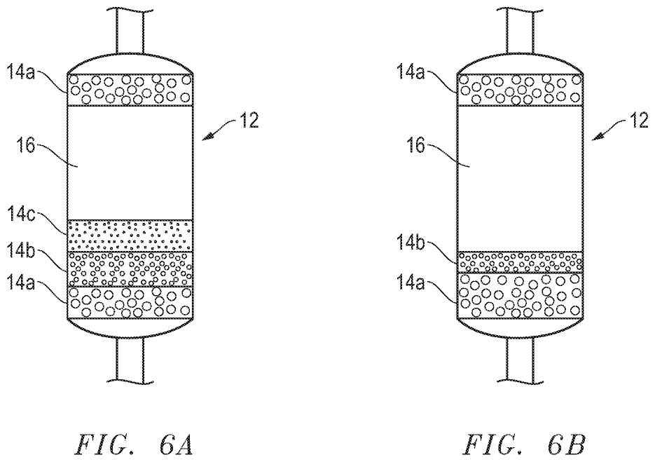

Wire on the catalyst support grid 26 is inspected and an outlet collector installed. Debris from the effluent pipes and catalyst dump nozzles is cleared. Catalyst loading hopper (not shown) is installed and loading sleeves on a top platform installed. The catalyst loading area is then covered with tarpaulin to protect catalyst 16 against rain or snow. For the required depth of each layer, a catalyst loading diagram is typically prepared and reviewed. Material Safety Data Sheets for the catalyst can be reviewed prior to catalyst loading to understand safety precautions required. Finally, a leak test is performed using water. FIGS. 4, 5A and 5B depict a typical three bed reactor 12 where the beds 18a, 18b, 18c are stacked one on top of each other. These figures are exemplary of loading drawings for a top reactor bed 18c (bed 1), reactor bed 18b (bed 2) and reactor bed 18a (bed 3 or the bottom bed), respectively.

### Methodology for Fixed Bed Reactor Sock Loading

Fixed bed reactor loading is typically performed by a person specialized in catalyst loading.

In this exemplary methodology of making a fixed bed reactor, multiple reactor beds are shown in FIGS. 4, 5A and 5B.

Before loading, reactor loading diagrams are prepared that show inert layering and catalyst bed elevations relative to the top flange face on the reactor loading manway. Cleanliness inside the reactor is checked as well as proper installation of reactor internals. A flow of dry instrument air is provided through the reactor bottom drain. The elevation of the inert layers and catalyst bed are marked on the inside surface of the reactor to aid in leveling the bed during loading. Catalyst loading commences with the manways at the bottom of reactor bed 2 and reactor bed 3 open to provide an access point for any emergency actions

### Loading Catalyst and Inert Particles to Produce Bed 3

Using a cone-bottomed loading hopper (not shown) and an attached wire-reinforced synthetic rubber sock 10, the hopper is positioned on the upper level platform with the sock extending into the reactor 12.

Inert particles 14 are then lifted to the loading hopper in a lifting hopper. Catalyst particles 16 can be supplied in Super Sacks which can be lifted and positioned over the loading hopper by crane. Personnel stationed inside the reactor load the appropriate material (inert particles, catalyst particles) through the sock attached to the loading hopper funnel. To avoid free-fall of the inert particles 14 or catalyst particles 16 and to minimize breakage, personnel are positioned on the catalyst support grid 26 for each reactor to temporarily restrict the flow of solids.

Reactor material is distributed evenly over the reactor 12 by moving the sock 10 around the periphery working progressively towards the center. When loading catalyst, the sock 10 is cut-off after every 0.3 meters of catalyst has been loaded. The sock 10 should be cut without emptying by tying off the sock 10 to stop catalyst flow. Cut pieces must be removed from the reactor 12. Catalyst loading should be paused to level the catalyst and measure the outage every 2 meters. Loaded density is calculated after each measurement to insure catalyst is loaded at uniform density.

### Loading Bottom Layer of Inert Particles

As shown in FIG. 5B, inert particles 14 are loaded into the bottom of the reactor (reactor bed 3). Freefall of reactor materials can be avoided by restricting the sleeve (tying off) at several elevations when filling the empty sleeve. If desired, a sturdy bag (canvas) may be used as an alternative to the sleeve for bottom loading. The volume of inert particles 14 can be estimated from the fixed bed reactor fabrication drawings.

### Loading Catalyst Particles

Catalyst particles 16 can be loaded using the conventional hopper or sleeve system. The sock is moved by the operator with a small circular motion to distribute the catalyst evenly over the reactor bed area. Catalyst particles 16 should not be poured into piles. During catalyst loading, pause loading every two meters to level the catalyst and measure the outage. The loaded density can be calculated after each measurement to insure catalyst is loading at a uniform density.

### Loading Top Layer of Inert Particles

As shown in these Figures, the reactor bed 18 is then topped with two different sizes of inert particles 14a, 14b. Both layers of inert particles are leveled and the outage of both layers recorded.

### Install Reactor Internals Between Reactor Bed 2 and Reactor Bed 3

A manway (not shown) is then installed for the reactor bed 3 distributor tray 20 and another manway for each of the bottom quench tray with mixing table 22 and the top quench tray with swirl mixing cap. If removed, the quench distributor 24 is installed. Center grid panels for the reactor bed 2 catalyst support grid 26 and the reactor bed 2 bottom manway plug and cover are installed.

Inert particles are then loaded into the bottom of reactor bed 2. The smaller inert particles are layered closest to the reactor bed 18. The layers are leveled and outage recorded. Each layer of inert particles 14 should be less than 0.5 m³ not including inert particles in the catalyst dump nozzle.

Reactor bed 2 catalyst is then loaded using a conventional hopper sleeve system. Here the sock 10 is moved with a small circular motion as it distributes catalyst evenly over the reactor bed area. Catalyst particles 16 should not be poured into piles. The catalyst loading is paused in order to level the catalyst and measure the outage every 2 meters. The loaded density is calculated after each measurement to insure catalyst is loaded at a uniform density.

Reactor bed 2 is then topped with two different sizes of inert particles 14a, 14b. As noted above, smaller inert particles 14b are loaded on top of the catalyst. Larger inert particles 14a are on top of the smaller inert particles 14a.

Reactor internals are then installed between reactor bed 1 and reactor bed 2. A manway is then installed for the reactor bed 2 distributor tray and another manway for each of the bottom quench tray with mixing table and the top quench tray with swirl mixing cap. (FIG. 4). If it was removed, the quench distributor is installed. Center grid panels for the reactor bed 1 catalyst support grid and the Bed 1 bottom manway plug and cover are installed.

Inert particles 14 are then loaded into the bottom of reactor bed 1. The smaller inert particle is always the layer that is closest to the reactor bed. The layers are leveled and outage recorded. Each layer of inert particles 14 is about 0.5 m³ excluding inert particles 14 in the catalyst dump nozzle.

Reactor bed 1 catalyst is then loaded using conventional hopper sleeve system. Here the sock is moved with a small circular motion as it distributes catalyst evenly over the reactor bed area. Catalyst particles 16 should not be poured into piles. The catalyst loading is paused in order level the catalyst and measure the outage every 2 meters. The loaded density is calculated after each measurement to insure catalyst is loaded at a uniform density.

Reactor bed 1 is then topped with grading materials to collect any scale from the piping. A layer of a low activity or hollow cylinder catalyst that reduces fouling from the olefins in the feed will be loaded next to the catalyst. The next layer can optionally be a sponge-like disk that collects any solids that enter the fixed bed reactor from the feed or process piping.

As part of the final loading steps, the manway for reactor bed 1 distributor tray and flash pan tray, and an inlet nozzle distributor are installed. Oxygen must be purposed from the reactor after catalyst is loaded and the inlet nozzles installed. Nitrogen purging plus pressuring to nitrogen supply and depressurizing cycles are conducted until the system content is less than 0.5 mole percent.

Certain features have been described using a set of numerical upper limits and a set of numerical lower limits. It should be appreciated that ranges from any lower limit to any upper limit are contemplated unless otherwise indicated. Certain lower limits, upper limits and ranges appear in one or more claims below. All numerical values take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

The foregoing description of the disclosure illustrates and describes the present methodologies. Additionally, the disclosure shows and describes exemplary methods, but it is to be understood that various other combinations, modifications, and environments may be employed and the present methods are capable of changes or modifications within the scope of the concept as expressed herein, commensurate with the above teachings and/or the skill or knowledge of the relevant art.

What is claimed is:

1. A sock for loading reactor material onto a reactor bed of a fixed bed reactor comprising a cylindrical tube having a plurality of helixes, each said helix of the cylindrical tube has a downward slope, wherein the downward slope of each said helix exceeds an angle of repose of the reactor material.

2. The sock for loading reactor material into a fixed bed reactor of claim 1, wherein the fixed bed reactor has a manway and at least one reactor bed.

3. The sock for loading reactor material into a fixed bed reactor of claim 2, the sock further comprising a proximal opening and a distal opening.

4. The sock for loading reactor material into a fixed bed reactor of claim 2, wherein the sock extends from a manway of the fixed bed reactor to the reactor bed.

5. The sock for loading reactor material into a fixed bed reactor of claim 3, wherein the proximal opening of the tube is positioned at a flange or the manway of the reactor and the distal opening is positioned at the reactor bed.

6. The sock for loading reactor material into a fixed bed reactor of claim 1, wherein the fixed bed reactor has a plurality of reactor beds.

7. The sock for loading reactor material into a fixed bed reactor of claim 1, wherein the sock comprises a plurality of segments.

8. The sock for loading reactor material into a fixed bed reactor of claim 7, wherein each segment is between about 1 feet and about 100 feet.

9. The sock for loading reactor material into a fixed bed reactor of claim 7, wherein the segments are configured to snap together.

10. The sock for loading reactor material into a fixed bed reactor of claim 1, wherein the sock is a canvas sock, a plastic sock, or a combination thereof.

11. The sock for loading reactor material into a fixed bed reactor of any of claim 1, further comprising a skeleton configured to maintain a helical shape of the sock.

12. The sock for loading reactor material into a fixed bed reactor of claim 1, further comprising a metal skeleton, a polymer skeleton, or a combination thereof.

13. A method of making a fixed bed reactor, comprising the steps of:
providing a sock for loading reactor material into a fixed bed reactor wherein the sock comprises a cylindrical tube having a plurality of helixes, each said helix of the cylindrical tube has a downward slope and the downward slope of each said helix exceeds an angle of repose of the reactor material; and
loading reactor material onto a bed of the fixed bed reactor, wherein flow of the reactor material through the sock to the reactor bed has attenuated free-fall.

14. The method of making a fixed bed reactor of claim 13, wherein the inert particles are loaded directly onto the reactor bed.

15. The method of making a fixed bed reactor of claim 13, wherein catalyst particles are dense loaded onto the reactor bed on top of inert particles.

16. The method of making a fixed bed reactor of claim 13, wherein inert particles are loaded on top of catalyst particles on the reactor bed.

17. The method of making a fixed bed reactor of claim 13, wherein two socks are coiled around each other to form a double helix and configured to transfer the reactor material through each sock.

18. A system for loading reactor material onto a reactor bed comprising:
a sock comprising a cylindrical tube having a plurality of helixes, each said helix of the cylindrical tube having a downward slope wherein the downward slope of each said helix exceeds an angle of repose of the reactor material; and
a fixed bed reactor having a manway flange and at least one reactor bed, wherein the sock is connected to the fixed bed reactor at the manway flange and open at the other end for depositing reactor materials onto the reactor bed.

19. The system of claim 18, further comprising a hopper configured to load reactor material into the fixed bed reactor, wherein the hopper is connected to the reactor and/or sock, and further comprising a dense loading system configured to provide a substantially uniform distribution of catalyst throughout the entire diameter of the fixed bed reactor.

20. The system for loading reactor material onto a reactor bed of any of claim 18, wherein the system comprises two socks coiled around each other to form a double helix.
